(19) United States
(12) Patent Application Publication
(10) Pub. No.: US 2008/0104267 A1
(43) Pub. Date: May 1, 2008

(54) Systems and methods for reducing display latency between streaming digital media

(75) Inventor: Thomas P. Dawson, Escondido, CA (US)

Correspondence Address: CROWELL & MORING LLP;INTELLECTUAL PROPERTY GROUP, P.O. BOX 14300, WASHINGTON, DC, 20044-4300, US

(73) Assignees: SONY CORPORATION, Tokyo (JP); SONY ELECTRONICS, INC., Park Ridge, NJ (US)

(21) Appl. No.: 11/591,912

(22) Filed: Nov. 1, 2006

(51) Int. Cl. G06F 15/16

(52) U.S. Cl. 709/231; 709/227

(57) ABSTRACT

A client-side device is able to request streaming media from a server over a network connection. In one embodiment, the client device sends streaming media requests to the server and, in response, a streaming media connection is established between the client-side device and the server in accordance with an appropriate networking protocol. Once this streaming media connection is established, the client-side device may make additional requests for other media streams. Delivery of such additional media streams may then proceed using the existing streaming media connection.

### FIELD OF THE INVENTION

The present invention relates, in general, to streaming digital media and, more particularly, to systems and methods for reducing the display latency when switching between different streaming digital media.

### BACKGROUND OF THE INVENTION

Distribution of streaming digital media (audio and video) has increased dramatically with the technological networking improvements. Streaming media is media that is consumed (heard or viewed) as it is being delivered. Steaming media is typical found in discrete segments or clips, although feature-length streams are becoming more common. Streaming is more a property of the delivery system than the media itself. The distinction is usually applied to content that is distributed over computer networks, with most other systems being either inherently streaming, such as radio and television, or inherently non-streaming.

Moreover, various protocols have been developed for streaming digital content. For example, datagram protocols, such as the User Datagram Protocol (UDP), send the media stream as a series of small packets. Real-Time Streaming Protocol (RTSP), Real-time Transport Protocol (RTP) and the Real-time Transport Control Protocol (RTCP) are also commonly-used for streaming digital content over networks. Other streaming protocols include Hypertext Transfer Protocol (HTTP) and Microsoft Media Server (MMS) protocol.

Streaming media is experienced in a server-client environment, using one of the aforementioned protocols, in which a server or other content source delivers the streaming media to a client-side system (e.g., personal computer) upon request. Once a host-client connection is established, the requested media is delivered to a streaming media player (e.g., Windows Media Player™, Flash Player™, Shockwave™, etc.) on the client-side, which in turn decodes and presents the streaming media to the user. Prior to being transmitted, the media stream is encoded into a particular format using what is referred to as a “codec.” Upon receiving the media stream, the media players detect the media type and use the appropriate codec to perform the decoding of the digital data stream.

However, when a user attempts to switch from one media stream to another, the existing server-client connection is first broken down, and an entirely new connection is established. This feature of streaming media systems has the distinct drawback of introducing a significant latency between the presentation of the previous media stream and the presentation of the new media stream. Accordingly, there is a need for a system and method which reduces the display latency when switching between different streaming digital content.

### SUMMARY OF THE INVENTION

Systems and methods for reducing display latency between streaming media are disclosed and claimed herein. In one embodiment, a system comprises a network, a server coupled to the network, and a client device coupled to the network. The client device is configured to request a first media stream from the server, establish a streaming media connection with the server, and receive the first media stream from the server over the established streaming media connection. The client device is further configured to request a second media stream from the server, and to receive the second media stream from the server over the previously-established streaming media connection.

Other aspects, features, and techniques of the invention will be apparent to one skilled in the relevant art in view of the following detailed description of the invention.

### BRIEF DESCRIPTION OF THE DRAWINGS

FIG. 1 depicts a simplified diagram of a system for implementing one or more aspects of one embodiment of the invention;

FIG. 2 is a flow diagram of a client-side process for implementing one embodiment of the invention;

FIG. 3 is a flow diagram of a server-side process for implementing one embodiment of the invention;

FIG. 4 is a flow diagram of a client-side process for implementing another embodiment of the invention; and

FIG. 5 depicts a more detailed diagram of a system for implementing one embodiment of the invention.

### DETAILED DESCRIPTION OF EXEMPLARY EMBODIMENTS

The disclosure relates to a client-server architecture in which a client-side device is able to request streaming media from a server over a network connection. In one embodiment, the client device sends streaming media requests to the server in the form of a command, such as a Universal Plug and Play (UPnP) command, an HTTP command, an RTSP command, a UDP command, etc. In response, a streaming media connection may then be established between the client-side device and the server in accordance with the appropriate protocol. Once this streaming media connection is established, the client-side device may make additional requests for other media streams. Delivery of such additional media streams may then proceed using the existing streaming media connection. Additional embodiments and features of the invention are described below.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium or transmitted by a computer data signal embodied in a carrier wave over a transmission medium or communication link. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc.

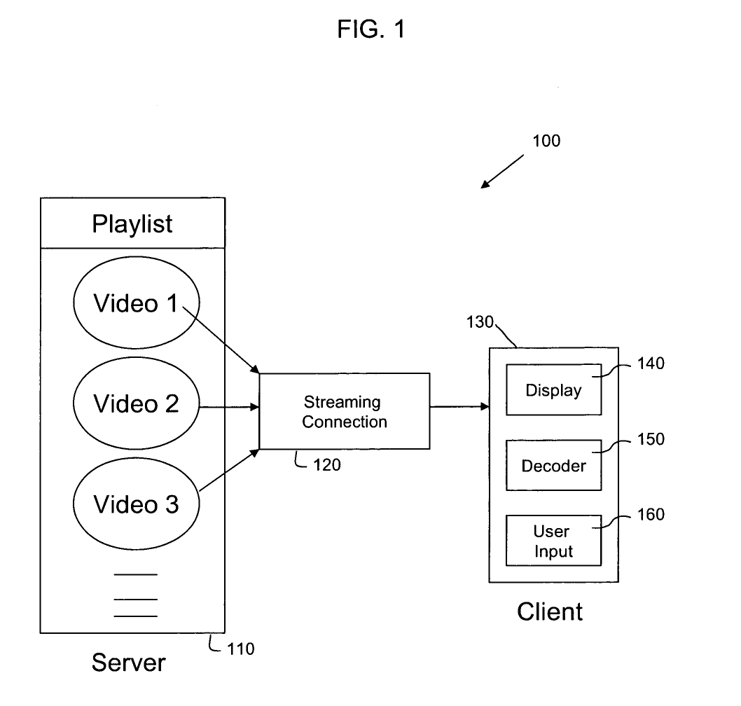

FIG. 1 depicts a simplified system 100 for implementing one embodiment of the invention. In particular, system 100 comprises a server 110 that has established a streaming media connection 120 with a client-side device 130. While in one embodiment, the client-side device may be a personal computer, laptop, personal digital assistant, cellular telephone or the like, it should be appreciated that the client-side device 130 may also be any device/system capable of receiving and presenting audio and/or video streaming media to a user. As depicted in the embodiment of FIG. 1, the client device 130 includes a display 140 for presenting streaming video media, a decoder 150 (e.g., media player) for decoding receiving streaming media, and a user input 160 for enabling a user to select a particular stream to receive. As will be described in more detail below, client device 130 may send streaming media requests to the server 110 in the form of a command, such as a Universal Plug and Play (UPnP) command, an HTTP command, an RTSP command, a UDP command, etc. The client device 130 may then present the requested streaming media to a user using, for example, a media player application.

Continuing to refer to FIG. 1, server 110 is shown as containing a series of video clips (Videos 1-3) organized as a playlist. As will be described in more detail below, a user may issue a request to receive a sequence (or playlist) of streaming media in succession without interruption. Alternatively, such playlists or sequences may be generated by the content provider or by one or more other users. In another embodiment, playlists may be shared among users, and may be based on one or more selection criteria (e.g., most watched, most recent, content category, etc.).

In order to minimize any latency in presenting the selected sequence, in one embodiment each of the Videos 1-3 are streamed from the server 110 to the client 130 using the existing streaming connection 120. That is, separate connections for each of the individual clips are not set up. As such, each clip in the defined playlist is presented using the originally-established connection and without the inherent delay associated with the typical connection breakdown and setup process associated with switching between media streams.

Although in one embodiment the streaming connection 120 may be an HTTP packet stream, it should equally be appreciated that any other streaming content protocol may be used (e.g., RTSP, UDP, etc.).

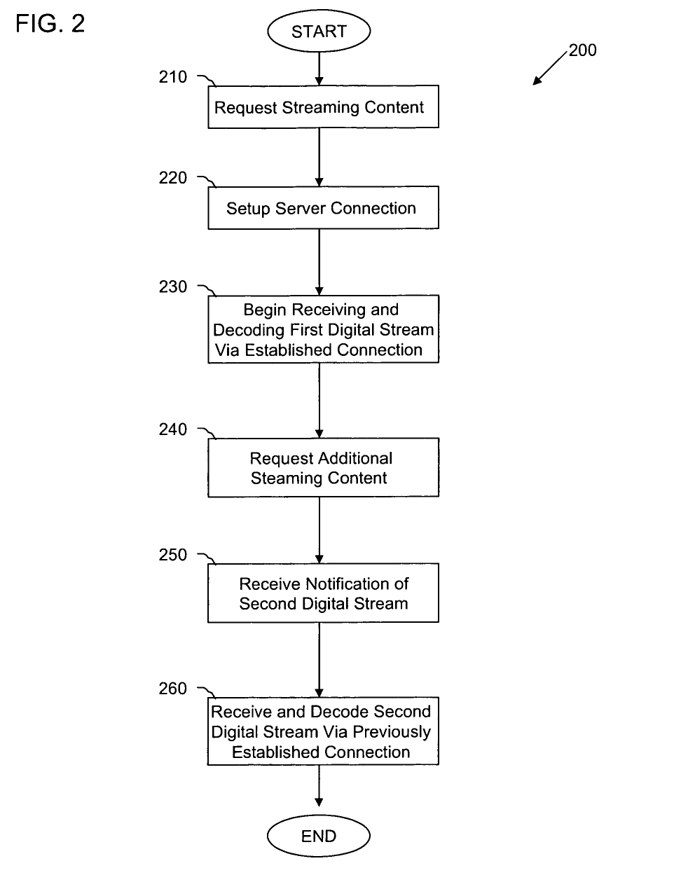

Referring now to FIG. 2, depicted is one embodiment of a process 200 to be carried out by a client-side device (e.g., client device 130) for implementing one or more aspects of the invention. In particular, process 200 begins with a client device requesting to receive a first digital stream at block 210 over a network connection (e.g., the Internet). It should of course be understood that a streaming media request may be made in any variety of ways, including for example, selecting an icon associate with desired streaming content from within a browser application while the client device is connected to a network. Moreover, the content request may be in the form of a UPnP, HTTP, RTSP, or UDP command.

Once a valid request is received and processed by a streaming media server (e.g., server 110), a streaming media connection may then be setup between the requesting client and the server (block 220). It should be appreciated that such a connection may include establishing one of an HTTP, RTSP or UDP connection. While process 200 has been described in terms of requesting streaming content (block 210) prior to establishing a streaming media connection (block 220), it should equally be appreciated that the order of these operations may be reversed in another embodiment, or performed simultaneously.

Process 200 continues to block 230 where the client device begins to receive and decode the requested streaming media content via the connection established at block 220. In one embodiment, the decoding operation may be performed by a media player application executing on the client device. As is generally known in the art, media player applications enable user to receive, view and/or hear streaming media. Moreover, most media players will enable the user to halt, rewind or otherwise navigate through the streaming media file.

At block 240, a user may then use the client device to request additional streaming content. As with the initial request, the request of block 240 may be in the form of a UPnP, HTTP, RTSP, or UDP command. Assuming the requested content is available and properly processed on the server side, process 200 will then continue to block 250 where a notification of the second media stream will be received by the client device. While in one embodiment such a notification may be sent through the existing streaming media connection (i.e., set up at block 220), it may similarly be sent through a separate connection.

In one embodiment, the notification received at block 250 may function to alert the media player/client device that a new media stream is about to be sent. The notification may further include the encoding format of the second digital stream so as to enable the media player to load the appropriate codec. To that end, the notification may be in the form of a command (e.g., UPnP, HTTP, RTSP, or UDP command) that causes the media player to switch decoding formats to the new format. The notification of block 250 may be a flag, marker or other set of bits which enables the media player to properly receive and decode the soon-to-be received second digital stream. In one embodiment, the codec type of the second digital stream may be embedded in the marker, flag, set of bits, etc.

At this point, process 200 may continue to block 260 where the client device begins to receive and decode the second requested digital stream via the same streaming connection that was previously established at block 220. The existing streaming media connection between the connected server and the client device is preserved and re-used for the new media stream. Accordingly, the typical delay experienced when switching between different media streams will not occur since the existing connection is not broken down and re-established. In one embodiment, the only potential delay between presenting the first stream and the second stream is associated with the media player having to load a new codec.

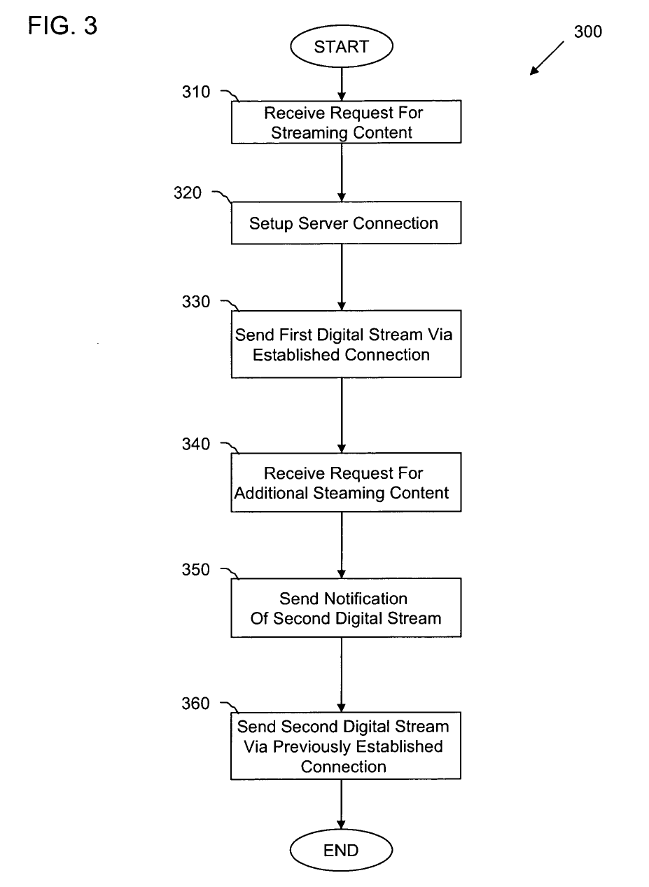

Referring now to FIG. 3, depicted is one embodiment of a process 300 to be carried out by a server (e.g., server 110) for implementing one or more aspects of the invention. In particular, process 300 begins with the server receiving a request for a first digital stream at block 310 over a network connection (e.g., the Internet). It should of course be understood that a streaming media request may manifest in any number of forming, including in the form of a UPnP, HTTP, RTSP, or UDP command.

Upon receiving and processing the request, and assuming the requested content is available and ready for transmission, a streaming media connection may be setup between the requesting client and the server (block 320). As with process 200 above, the streaming connection of block 320 may include establishing one of an HTTP, RTSP or UDP connection. As with process 200, the order of receiving a request for streaming content (block 310) and establishing a streaming media connection (block 320) may be reversed in another embodiment, or performed simultaneously.

Process 300 continues to block 330 where the server begins to encode and send the requested streaming media content via the connection established at block 320. Process 300 then continues to block 340, where a request is received from the connected client device to request additional streaming content. As with the initial request, the request of block 340 may be in the form of a UPnP, HTTP, RTSP, or UDP command. Assuming the requested content is available and properly processed on by the server, process 300 may then continue to block 350 where the server sends a notification to the connected client device indicating that the second media stream is about to be sent. As with process 200, such a notification may be sent through the existing streaming media connection (i.e., set up at block 320), or it may similarly be sent through a separate connection. It should be appreciated that the notification sent at block 350 may function similar to, and take on the various forms as the notification discussed above with reference to block 250.

Continuing to refer to FIG. 3, process 300 may then continue to block 360 where the server begins to send the second requested digital stream via the same streaming connection that was previously established at block 320. As with process 200, the existing streaming media connection between the connected server and the client device may be preserved and re-used for the new media stream, thereby minimizing the delay experienced when switching between the different media streams

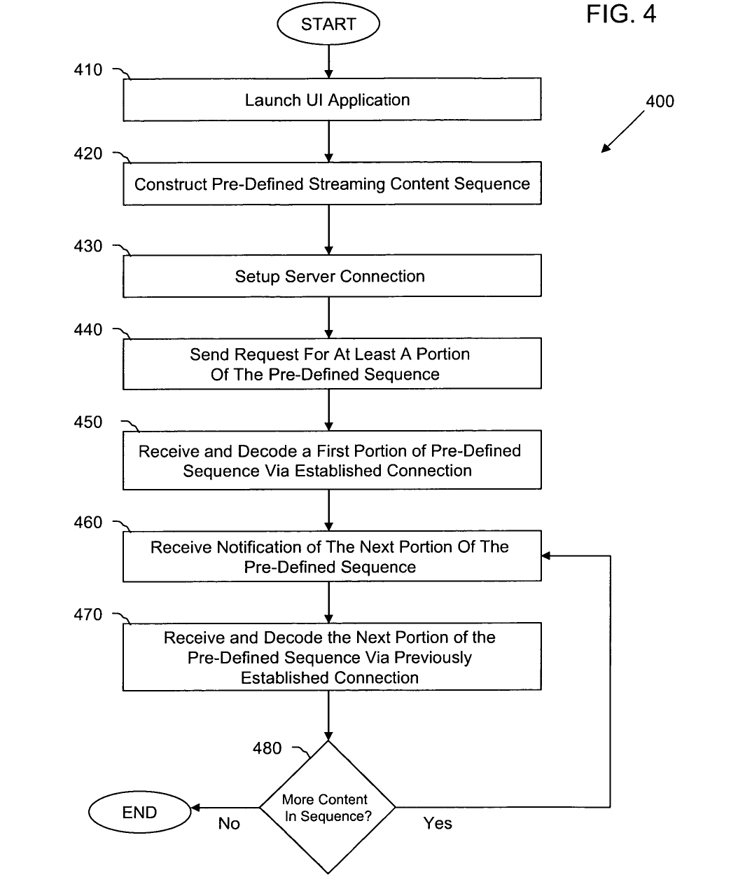

FIG. 4 depicts still another embodiment for a process 400 to be carried out by a client-side device (e.g., client device 130) for implementing one or more aspects of the invention. Process 400 begins at block 410 with the launching or executing of a user interface (UI) application on the client device, where the UI application enables a user to select streaming media to download. While in one embodiment the UI application may be integrated into a media player, it may similarly be part of a Internet browser application or even a stand-alone application. Regardless, process 400 continues to block 420 where a sequence of pre-defined media streams may be constructed using the UI application. In one embodiment, this sequence is functions as a playlist made up of individual media streams that are to be sequentially streamed to the client device in the indicated order. It should be appreciated that numerous means for constructing the sequence of block 420 may be used. However, in one embodiment individual media streams may be dragged-and-dropped into the UI application from, for example, a browser application. Additionally, such playlists may be generated by the content provider or by one or more other users. Playlists may be shared among users, and may be based on one or more selection criteria (e.g., most watched, most recent, content category, etc.).

Process 400 continues to block 430 where a streaming media connection may then be setup between the requesting client and a server (e.g., server 110). As previously discussed, such a connection may include establishing one of an HTTP, RTSP or UDP connection. However, the establishment of a streaming media connection may similarly have occurred earlier in process 400.

At this point, process 400 may proceed to block 440 where the client device sends a request to receive at least a portion of the pre-defined media sequence (i.e., playlist) that was constructed above at block 420. As with the previously-described media stream requests, the request of block 440 may also be in the form of a UPnP, HTTP, RTSP, or UDP command. Also, the request may be for all or any subset of the sequence.

Assuming the request of block 440 is received and properly processed by the connected server, process 400 continues to block 450 where the client device will begin to receive and decode a first portion (e.g., clip) of the pre-defined sequence via the connection established at block 430. In one embodiment, the decoding operation may be performed by a media player application executing on the client device.

Either in response to nearing the end of the first portion of the streaming sequence, or in response to a separate user request, process 400 may continue to block 460 where a notification that the next portion of the user-defined sequence is about to be sent to the client device. While in one embodiment such a notification may be sent through the existing streaming media connection, it may similarly be sent through a separate connection. This notification may function similar to, and take on the various forms as the notification discussed above with reference to FIGS. 2 and 3. In particular, the notification received at block 460 may include the encoding format of the next portion of the sequence so as to enable the media player to load the appropriate codec. To that end, the notification may be in the form of a command (e.g., UPnP, HTTP, RTSP, or UDP command) that causes the media player to switch decoding formats to the new format. The notification of block 460 may be a flag, marker or other set of bits which enables the media player to properly receive and decode the soon-to-be received second digital stream.

At this point, process 400 may continue to block 470 where the client device begins to receive and decode the next portion of the pre-defined streaming media sequence using the same streaming connection that was previously established at block 430. As with processes 200 and 300 described above, the existing streaming media connection between the connected server and the client device is preserved and re-used for the new portion of the sequence thereby eliminating the typical delay experienced when switching between different media streams.

Process 400 will then continue to block 480 where a determination may be made as to whether there are additional portions/clips in the user-defined sequence to stream to the user. If so, process 400 returns to block 460 where another notification is sent to prepare the media player/client device for the next portion. Again, the already-established streaming media connection may be used for all such subsequently streamed portions in the user-defined sequence. If there are no additional media streams selected, process 400 may end.

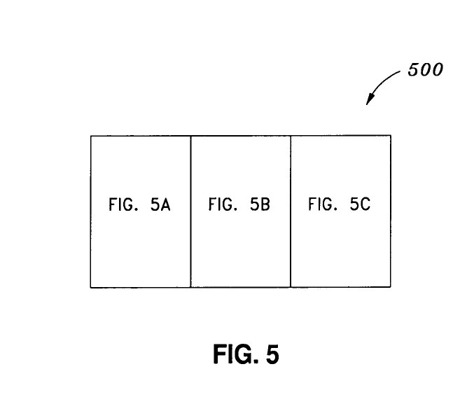

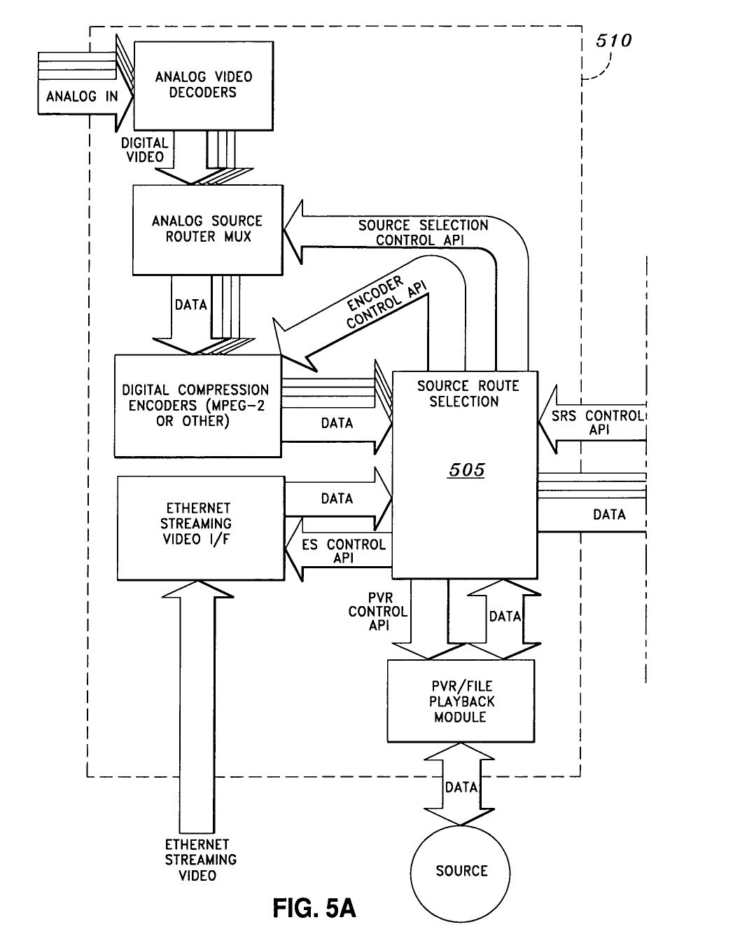

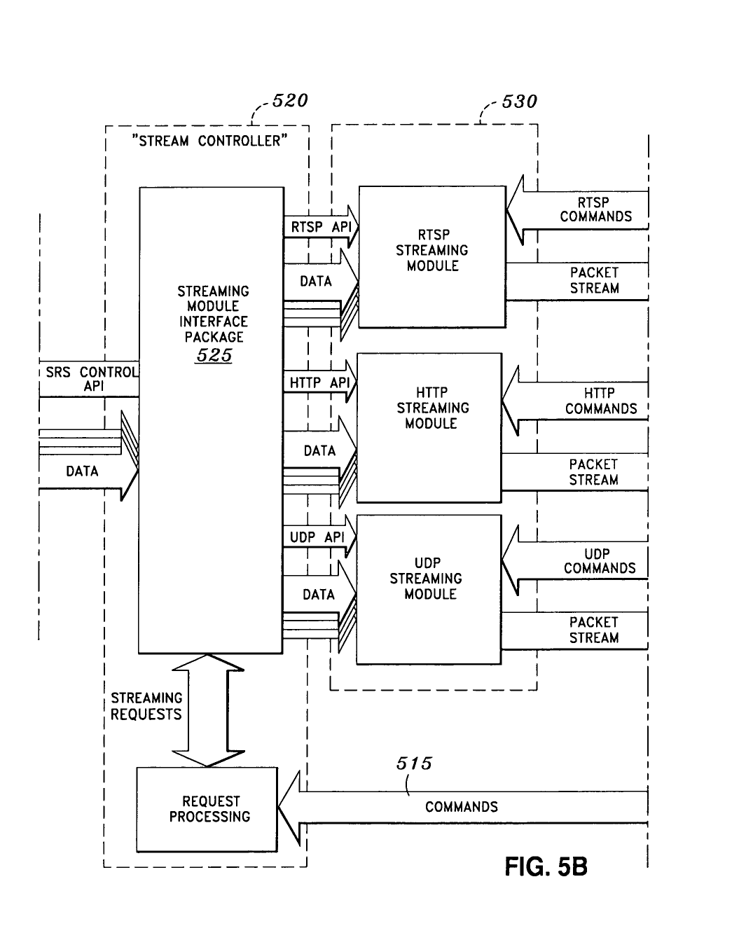

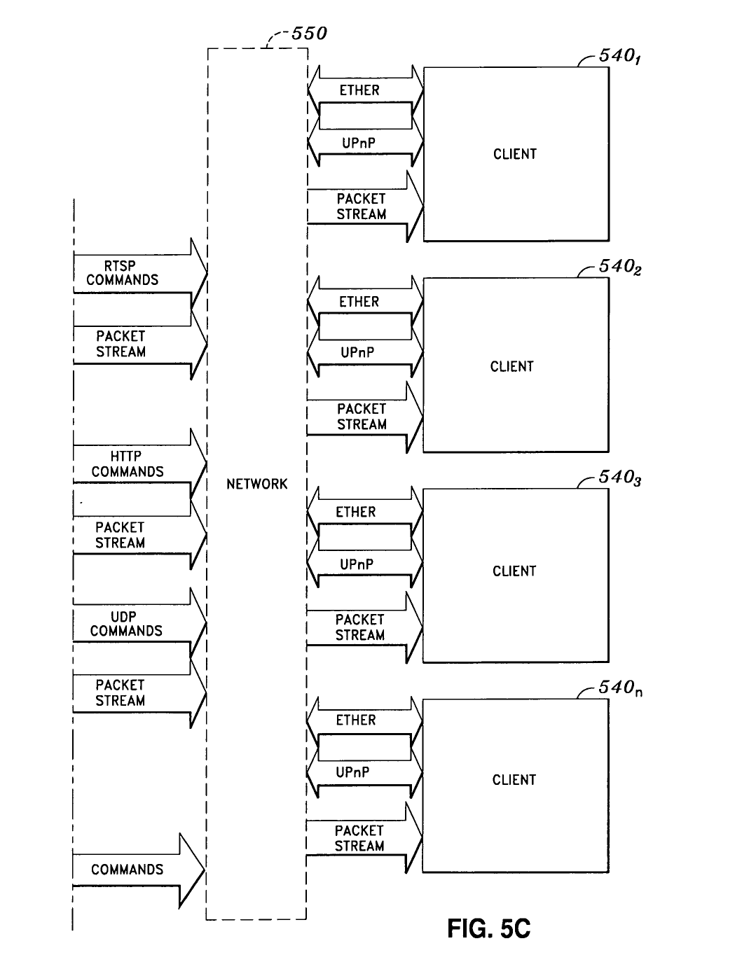

Referring now to FIG. 5, depicted is a more detailed diagram of another embodiment of a system 500. A server-side of the system 500 comprises a source control module 510, a stream controller 520 and a stream module 530. In one embodiment, the system 500 is a home media server system, but may similarly be an Internet-based or other networked system. As shown, the stream controller 520 includes a streaming module interface package 525 that routes data to a packetizer based on the requested protocol. In one embodiment, the packetizer is the stream module 530, which in turn interfaces with a plurality of client-side devices 540₁-540ₙ via a network connection 550. While in one embodiment the client-side device may be a personal computer, laptop, personal digital assistant, cellular telephone or the like, it should be appreciated that the client-side devices 540₁-540ₙ may be any device/system capable of receiving and presenting audio and/or video streaming media to a user.

Source control module 510, which may be built as a set of link libraries, includes a source route selection (SRS) module 505 for handling source selection, source switching and routing of digital media streams. A shown, the SRS module 505 may have a number of media stream sources, and use application programming interfaces (APIs) to control source selection and/or encoder control.

Requests (e.g., UPnP, HTTP, RTSP, UDP commands) 515 may be received by the stream controller 520 from a client-side device 540₁-540ₙ. In the context home networks, requests 515 may be UPnP commands. In response, the stream controller 520 issues commands/requests via a control API to the SRS module 505 (and hence the source control module 510). Based on the selected streaming protocol, the stream controller 520 may then select the appropriate type of streaming module 530 to establish a connection with a client-side device 540₁-540ₙ. In accordance with one aspect of the invention, a change in the media stream source will result in an SRS API control request being sent to the source module 510 to select the new source, however, the existing streaming module 530 will remain unchanged.

For the sake of simplicity, processes 200, 300 and 400 have been defined in general steps and it should be appreciated that other steps consistent with the principles of the invention may be included. It should further be appreciated that all of the various operations of processes 200, 300 and 400 may be implemented in software, hardware or a combination thereof.

While the invention has been described in connection with various embodiments, it should be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A system comprising:
a network;
a server coupled to the network; and
a client device, coupled to the network, the client device configured to,
request a first media stream from the server,
establish a streaming media connection with the server,
receive the first media stream from the server over the established streaming media connection,
request a second media stream from the server, and
receive the second media stream from the server over said established streaming media connection.

2. The system of claim 1, wherein the request for the first media stream and the request for the second media stream are one of a universal plug and play command, a hypertext transfer protocol command, a real-time streaming protocol command, and a user datagram protocol command.

3. The system of claim 1, wherein the client device is further configured to receive a notification from the server indicating that the second media stream is being sent.

4. The system of claim 3, wherein the notification further includes an indication of a file format for the second media stream.

5. The system of claim 4, wherein the client device is further configured to execute a decoder in response to the notification in accordance with said file format.

6. The system of claim 1, wherein the streaming media connection has a network protocol selected from the list consisting of: user datagram protocol, real-time streaming protocol, real-time transport protocol, real-time transport control protocol, hypertext transfer protocol and Microsoft Media Server protocol.

7. The system of claim 1, wherein the client device is further configured to execute a media player application for presenting the first and second media streams.

8. The system of claim 7, wherein the media player application presents the first and second media streams without a reconnection delay.

9. The system of claim 1, wherein the requests for the first and second media streams are sent as at least a portion of a pre-defined media stream sequence.

10. A system comprising:
a network;
a client device, coupled to the network; and
a server coupled to the network, the server configured to,
receive request for a first media stream from the client device,
establish a streaming media connection with the client device,
send the first media stream to the client device over the established streaming media connection,
receive a request for a second media stream from the client device, and
send the second media stream over said established streaming media connection.

11. The system of claim 10, wherein the request for the first media stream and the request for the second media stream are one of a universal plug and play command, a hypertext transfer protocol command, a real-time streaming protocol command, and a user datagram protocol command.

12. The system of claim 10, wherein the server is further configured to send a notification to the client device indicating that the second media stream is being sent.

13. The system of claim 12, wherein the notification further includes an indication of a file format for the second media stream.

14. The system of claim 10, wherein the streaming media connection has a network protocol selected from the list consisting of: user datagram protocol, real-time streaming protocol, real-time transport protocol, real-time transport control protocol, hypertext transfer protocol and Microsoft Media Server protocol.

15. The system of claim 10, wherein the first and second media streams are sent to the client device without a reconnection delay.

16. The system of claim 10, wherein the requests for the first and second media streams are received as at least a portion of a pre-defined media stream sequence.

17. A method for streaming media from a server to a client device over a network, the method comprising the acts of:
requesting a first media stream from the server;
establishing a streaming media connection between the client device and the server;
receiving the first media stream from the server over the established streaming media connection;
requesting a second media stream from the server; and
receiving the second media stream from the server over the established streaming media connection.

18. The method of claim 17, wherein requesting the first media stream comprises sending a command for the first media stream to the server, where the command is one of a universal plug and play command, a hypertext transfer protocol command, a real-time streaming protocol command, and a user datagram protocol command.

19. The method of claim 17, further comprising receiving a notification from the server indicating that the second media stream is being sent.

20. The method of claim 19, wherein the notification further includes an indication of a file format for the second media stream.

21. The method of claim 20, further comprising executing a decoder in response to the notification in accordance with said file format.

22. The method of claim 17, wherein the streaming media connection has a network protocol selected from the list consisting of: user datagram protocol, real-time streaming protocol, real-time transport protocol, real-time transport control protocol, hypertext transfer protocol and Microsoft Media Server protocol.

23. The method of claim 17, further comprising executing a media player application to present the first and second media streams.

24. The method of claim 23, wherein the media player application presents the first and second media streams without a reconnection delay.

25. The method of claim 17, wherein said requesting the first and second media streams comprises sending at least a portion of a pre-defined media stream sequence to the server.
